(19) United States
(12) Patent Application Publication
(10) Pub. No.: US 2016/0147304 A1
(43) Pub. Date: May 26, 2016

(54) HAPTIC FEEDBACK ON THE DENSITY OF VIRTUAL 3D OBJECTS

(71) Applicant: General Electric Company, Schenectady, NY (US)

(72) Inventors: Arnold Lund, Oakland, CA (US); Jeng-Weei Lin, Danville, CA (US)

(21) Appl. No.: 14/552,071

(22) Filed: Nov. 24, 2014

(51) Int. Cl. G06F 3/01; G06F 19/00; G06F 3/0484; G06T 15/00; G06F 3/0481

(52) U.S. Cl. CPC G06F 3/016; G06T 15/00; G06F 3/014; G06F 3/04815; G06F 3/04845; G06F 19/321; G06T 2207/10088; G06T 2207/10081; G06T 2207/30004

(57) ABSTRACT

Systems and methods are presented for visualizing a 3-dimensional (3-D) image and providing haptic feedback to a user when the user interacts with the 3-D image. In some embodiments, a method is presented. The method may include accessing, in a wearable visualization device, density data of a physical structure. The method may further include generating a three-dimensional image of the physical structure based on the density data, displaying the three-dimensional image in the wearable visualization device, receiving manipulation data associated with the three-dimensional image from a haptic device, and providing haptic feedback data associated with the three-dimensional image, to the haptic device, based on the manipulation data.

### TECHNICAL FIELD

The subject matter disclosed herein generally relates to visualizing techniques using wearable devices. In some example embodiments, the present disclosure relates to systems and methods for visualizing a 3-D image and interacting with the 3-D image using haptic feedback.

### BRIEF DESCRIPTION OF THE DRAWINGS

Some embodiments are illustrated by way of example and not limitation in the figures of the accompanying drawings.

FIG. 1 is an example network diagram illustrating a network environment suitable for visualizing a 3-D image and interacting with the 3-D image using haptic feedback, according to some example embodiments.

FIG. 2 illustrates a collection of devices that may be configured for visualizing 3-D images and for interacting with the 3-D images using haptic feedback, according to some example embodiments.

FIG. 3 is an example image of a patient's knee, which can be an example image displayed in a wearable device, according to aspects of the present disclosure.

FIG. 4 is a modified version of the 3-D image of the patient's knee, according to some example embodiments.

FIG. 5 illustrates an example method, according to some example embodiments, for visualizing a structure in a virtual 3-D environment and for interacting with the structure.

FIG. 6 illustrates another example method, according to some example embodiments, for visualizing a structure in a virtual 3-D environment and for interacting with the structure.

FIG. 7 is a block diagram illustrating components of a machine, according to some example embodiments, able to read instructions from a machine-readable medium and perform any one or more of the methodologies discussed herein.

### DETAILED DESCRIPTION

Example methods, apparatuses, and systems are presented for visualizing a 3-dimensional (3-D) image and providing haptic feedback to a user when the user interacts with the 3-D image. Example use cases may be in the medical field context. For example, a 3-D image of an internal structure (e.g., a patient's knee, internal organ, muscle or the like) of a patient may be constructed using multiple medical imaging scans, such as multiple magnetic resonance imaging (MRI) scans or multiple computerized tomography (CT) scans showing different cross-sections of the internal structure that can be combined to create the constructed 3-D image as a whole. In some example embodiments, the constructed 3-D image can be visualized in a wearable device, such as wearable goggles configured to display the constructed 3-D image for a user.

In some example embodiments, the 3-D image can be interacted with using a haptic feedback device, such as gloves with haptic feedback functionality. The user, such as a doctor, can wear the goggles to view the 3-D image, and then can wear the gloves to interact with the 3-D image with his hands. The movement of the gloves can correspond to manipulating the 3-D image, such as rotating and “touching” the image. The gloves can provide haptic feedback to the user that can correspond to different features of the image. For example, the gloves can provide movement resistance if the user tries to move his hands into the 3-D image, simulating different densities of the object in the image. As another example, the gloves can provide different heat sensations corresponding to different levels of density as the user moves his hands into the image. In some cases, the density measurements of the object can be based on data from the multiple image scans, such as multiple MRI or CT scans.

In some example embodiments, different density layers can be removed or modified from the constructed 3-D image, which can allow the user to examine and interact with different layers of the 3-D image. In some cases, the techniques presented herein can be used for diagnostic purposes, such as for diagnosing medical problems of a patient in a less invasive manner. In some example embodiments, the techniques presented herein can be applied to different technical fields, such as examining electromechanical structures, such as in an engine or motor.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

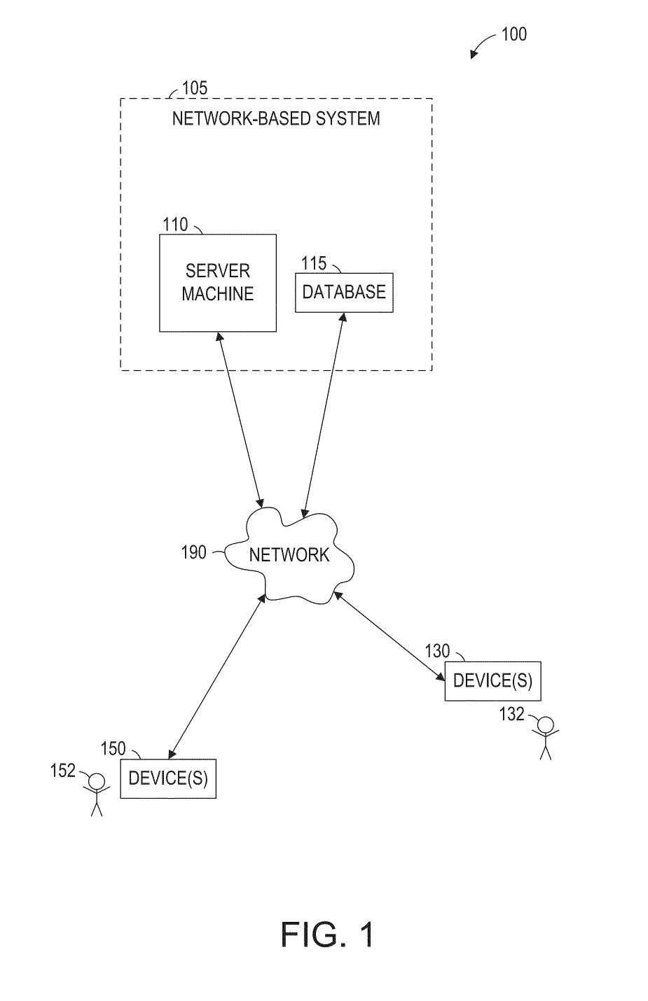

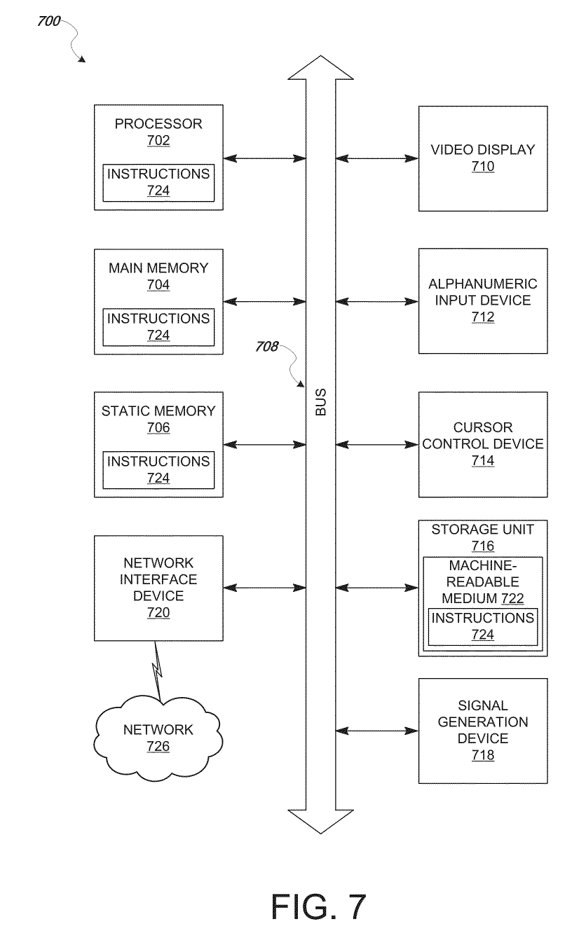

Referring to FIG. 1, an example network diagram illustrating a network environment 100 suitable for visualizing a 3-D image and interacting with the 3-D image using haptic feedback is shown, according to some example embodiments. The network environment 100 includes a server machine 110, a database 115, a first device or devices 130 for a first user 132, and a second device or devices 150 for a second user 152, all communicatively coupled to each other via a network 190. The server machine 110 may form all or part of a network-based system 105 (e.g., a cloud-based server system configured to provide one or more services to the devices 130 and 150). The database 115 can store image data for the devices 130 and 150. The server machine 110, the first device(s) 130 and the second device(s) 150 may each be implemented in a computer system, in whole or in part, as described below with respect to FIG. 7.

Also shown in FIG. 1 are users 132 and 152. One or both of the users 132 and 152 may be a human user, a machine user (e.g., a computer configured by a software program to interact with the device 130), or any suitable combination thereof (e.g., a human assisted by a machine or a machine supervised by a human). The user 132 may be associated with the device(s) 130 and may be a user of the device(s) 130. For example, the device(s) 130 may include a desktop computer, a vehicle computer, a tablet computer, a navigational device, a portable media device, a smartphone, or a wearable device (e.g., a smart watch, smart glasses, smart gloves) belonging to the user 132. Likewise, the user 152 may be associated with the device(s) 150. As an example, the device(s) 150 may be a desktop computer, a vehicle computer, a tablet computer, a navigational device, a portable media device, a smartphone, or a wearable device (e.g., a smart watch, smart glasses, smart gloves) belonging to the user 152.

Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 7. As used herein, a “database” may refer to a data storage resource and may store data structured as a text file, a table, a spreadsheet, a relational database (e.g., an object-relational database), a triple store, a hierarchical data store, any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

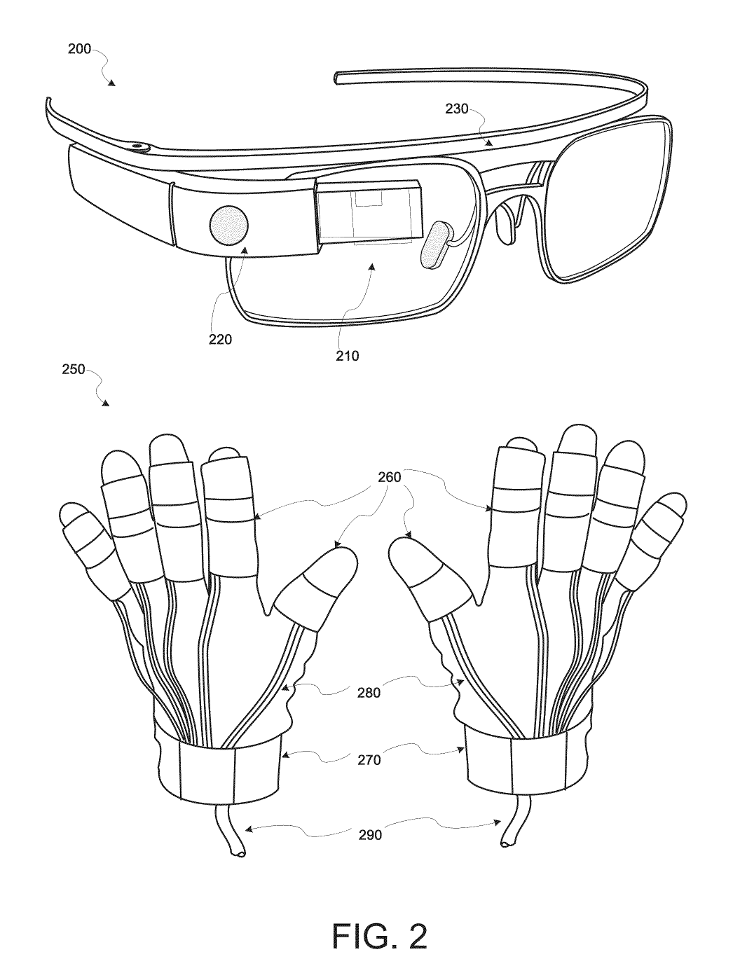

Referring to FIG. 2, a collection of devices 200 and 250 that may be configured for visualizing 3-D images and for interacting with the 3-D images using haptic feedback are shown, according to some example embodiments. The devices 200 and 250 may be consistent with the descriptions of the device(s) 130 and 150, described in FIG. 1. The device 200 may be a wearable device configured to display images within a user's field of view. Examples can include smart goggles, augmented reality (AR) goggles, and virtual reality (VR) goggles, among others. The wearable device 200 may include a micro-projector 210, which may be configured to display images into the field of view of the user.

The device 250 may be a wearable device in the form of gloves, configured to respond to movements of the user's hands and fingers. Haptic feedback sensors 260 may be placed over each of the appendages of the device 250. The haptic feedback sensors 260 may be connected to input wires 280, which may be connected to location calibration sensors 270. In some example embodiments, the haptic feedback sensors 260 may be configured to access or receive movement data from the user's appendages when the user is wearing the device 250. For example, the haptic feedback sensors 260 can detect when the user's right thumb is moving, including in some cases a degree of movement, such as detecting the difference between a small wiggle and a more drastic sweeping motion of the thumb. The movement data from each of the haptic feedback sensors 260 can be transmitted through the input wires 280 down to the location calibration sensors 270.

The location calibration sensors 270 can be configured to calibrate an initial position of each of the gloves of the device 250. For example, when used for diagnostic purposes, the user can wear the gloves of the device 250, and an initial position of the user's hands can be recorded using the location calibration sensors 270. The location calibration sensors 270 can be equipped with various location sensors, such as one or more altimeters, one or more accelerometers, and one or more positions sensors that can interact with one or more fixed reference points, such as laser or sonar sensors that can be used to measure relative location to one or more fixed reference points, not shown. The initial position of the device 250 can be calibrated with an initial position in the field of view of the device 200. Changes in position of the device 250 and movements of the appendages based on movements detected by the haptic feedback sensors 260 can then be measured relative to the initial calibrated position of the device 250. Thus, the device 250 can provide data to another device that communicates a change in position or change in movement of the user's hands and appendages while wearing the device 250.

The movement data from both the haptic feedback sensors 260 and the location calibration sensors 270 can be transmitted through various means, including the wires 290. In other cases, the movement data can be transmitted wirelessly, via Bluetooth® or other known wireless means, not shown. Ultimately, the movement data can be transmitted to the device 200, which may be displaying a 3-D image into the user's field of view via a micro-projector 210, for example. In some cases, the processor 220 of the device 200 can track the movements of the device 250 via the movement data provided to it by the device 250. For example, the processor 220 can compute the positions of the user's hands and each of his appendages based on the changes in position relative to the initial position, provided by the movement data. Thus, the device 200 can track or map the user's hand positions. In some cases, one or more cameras 230 can also be used to track the movements of the device 250. In some cases, if there are at least two cameras 230, then the cameras 230 can also track depth and perspective of the positions of the device 250.

Based on the above descriptions, the device 200 can be configured to keep track of the user's hand movements as well as control the position and placement of a 3-D image shown through micro-projector 210. Therefore, the device 200 can keep track of where the user's hands may be placed in the field of view relative to where the 3-D image is positioned or placed in the user's field of view. In other words, the device 200 can determine if the user's hands are passing through or “touching” any portion of the 3-D image.

If it is determined that the user's hands, through the positions of the device 250, are touching a portion of the 3-D image, the processor 220 of the device 200 may be configured to transmit haptic feedback data to the device 250. The haptic feedback data can ultimately be transmitted to the haptic feedback sensors 260, in some cases via wires 290 and input wires 280. The haptic feedback sensors 260 can then express the haptic feedback data through one or more different sensory functions. For example, the haptic feedback sensors 260 can cause a vibrating sensation to the appendages of device 250 when the user is “touching” a portion of the 3-D image. In other cases, the haptic feedback sensors 260 can constrict, stiffen, or tighten at the joints of the appendages of the device 250, in order to simulate the user touching the 3-D image. Other kinds of haptic feedback sensations can be experienced by the user according to some example embodiments, some of which will be described more below.

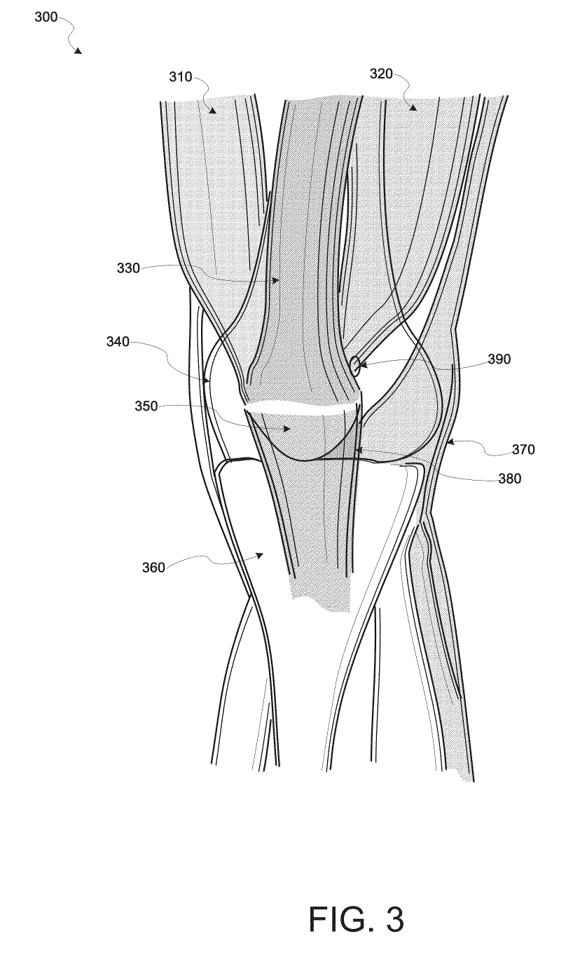

Referring to FIG. 3, an example image 300 of a patient's knee is shown, which can be an example image displayed in the device 200, according to some example embodiments. According to aspects of the present disclosure, a 3-D image can be visualized in one or more wearable devices, such as device 200. However, example image 300 is used as an example that can be displayed in the device 200, and is a two-dimensional image merely because of the limitations of these descriptions being expressed on a flat surface.

For example, image 300 (that may be interpreted as a 3-D image) may be a series of two-dimensional (2-D) scans of a patient's knee, where each of the two-dimensional scans may be a different cross-section of the patient's knee. The plurality of 2-D scans may be generated using various kinds of imaging techniques, such as MRI scans or CT scans. The plurality of 2-D scans may be stored in a memory of a device, such as the device 200, or a machine in the network-based system 105, for example. In some example embodiments, a 3-D image may be generated using the plurality of 2-D scans. For example, a processor in the server machine 110 may access the plurality of 2-D scans and may generate a 3-D image by lining up or stacking the multiple cross-sections of the patient's internal structure and reconstructing a 3-D image of the patient's internal structure using the multiple cross-sections as multiple layers of the internal structure.

In this case, a 3-D image of a patient's knee may have been reconstructed using multiple MRI or CT scans. The image 300 can show various parts of the patient's knee. For example, the image 300 may show the vastus lateralis muscle 310, the vastus medialis muscle 320, the patellar tendon 330, the synovial capsule 340, the kneecap 350, the tibia bone 360, the tibial collateral ligament 370, and the anterior cruciate ligament 380. In addition, a cyst 390 may be shown in the patient's knee, but may be obscured by the various other body parts surrounding it.

A user of the device 200 and device 250, according to aspects of the present disclosure, may desire to examine the image 300 in more detail. For example, the user may be a doctor trying to diagnose problems with a patient's knee. As described earlier, the user may be able to visualize a 3-D image of image 300 using the device 200. In addition, the user may be able to interact with and manipulate the image 300 using the device 250, while viewing the image 300 in the device 200. For example, consistent with the descriptions in FIG. 2, while the image 300 is within the user's field of view via the device 200, the user's hands can manipulate the device 250 in order to “touch” the image 300 by experiencing haptic feedback through a coordination and calibration between devices 200 and 250.

In some cases, the haptic feedback transmitted to the user through the device 250 can be based on varying levels of density conveyed in the image 300. For example, the muscles 310 and 320 physically have a different density than the tibia bone 360, or the tendon 330, as examples. Similarly, the cartilage in the kneecap 350 has a different density than the other structures. Moreover, the cyst 390 also has a different density than the other structures. The densities of each of the structures described in image 300 can be measured based on the imaging techniques used to generate the cross-sectional images in the first place. In other words, MRI and CT scans generate various images based on the densities of the various structures being scanned. These varying densities are often expressed in various color gradations, and can similarly be used to express different haptic feedback sensations based on said densities.

Thus, for example, as a user interacts with the image 300 using the device 250, the haptic feedback sensors 260 can generate different haptic sensations as the user passes his hands through different densities expressed in the image 300. For example, the haptic feedback sensors 260 can cause vibrating sensations at the appendages of the device 250, and the vibrating sensations can be stronger where the material of image 300 being passed through is denser. For example, as the user passes his hand via the device 250 through the tibia bone 360, he may receive strong vibrating sensations from the haptic feedback sensors 260, and may receive milder vibrating sensations from the haptic feedback sensors 260 as he passes his hand through the kneecap 350. Similarly, the user may receive very mild or light vibrating sensations as he passes his hand through the cyst 390. In this example, the user may be able to tangibly locate the cyst 390 based on finding a structure with an abnormal density level, which may be a problem expressed by the patient. In this way, aspects of the present disclosure allow for a user to tangibly interact with a 3-D reconstruction of a structure based on varying densities in the structure.

In some example embodiments, the device 250 can be configured to provide different types of haptic feedback. For example, instead of a vibrating sensation, the varying densities in a structure could be expressed by stiffening, tightening, or constricting the movements of the appendages in the device 250. As another example, varying levels of heat sensation could be transmitted through the haptic feedback sensors 260, based on varying levels of density (e.g., colder means less dense, or vice versa).

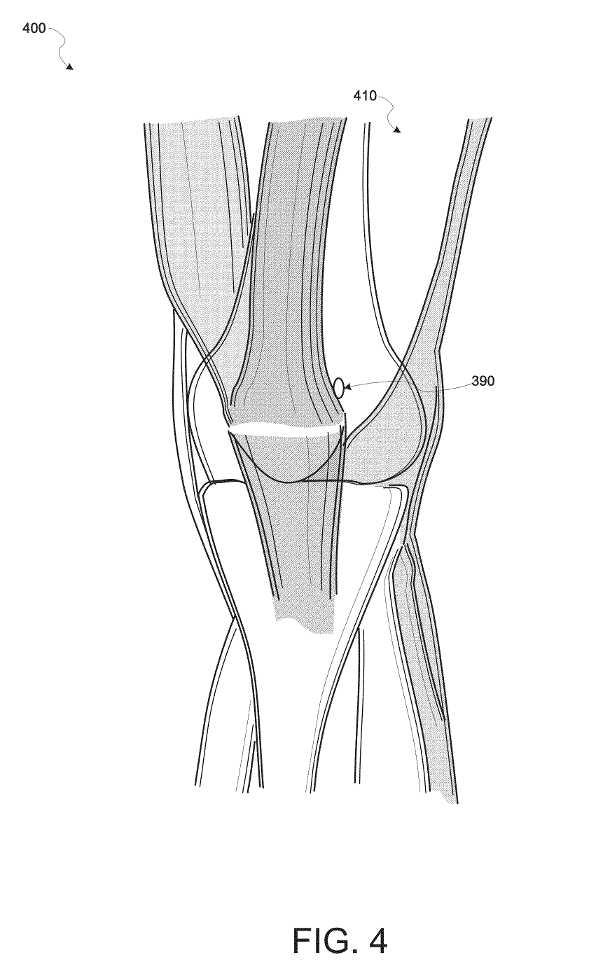

Referring to FIG. 4, in some example embodiments, a reconstructed 3-D image can be modified for further diagnostic analysis. For example, various structures of an image can be modified or removed based on the density of the structure. Image 400 shows a modified version of the 3-D image of the patient's knee, according to some example embodiments. Here, the vastus medialis muscle 320 has been removed from the image 400, as shown in the open space 410. In some example embodiments, the device 250 can receive inputs to identify certain structures based on having a consistent density level across the entirety of the structure. For example, a particular hand motion or voice command can be received by either the device 200 or the device 250, to signal a particular structure for modification or removal. For example, the user may place his finger via the device 250 into the space of image 300 having the vastus medialis muscle 320. The user may then make a motion with his other free hand, such as a clasping motion or grabbing motion. The device 250 may recognize this motion as “selecting” the particular structure being “touched” by the user. While the user is still touching the vastus medialis muscle 320, with the user's free hand, the user can then make a swiping motion, which may represent an action to remove that structure from the image 300, resulting in the image 400. As another example, the device 250 or the device 200 may be configured to accept the voice commands to perform the same functions. In some example embodiments, various other kinds of emotions or voice commands known to those with skill in the art can be used to perform the same functions, and embodiments are not so limited.

After the user has “removed” the vastus medialis muscle 320, the resulting open space 410 may allow the user to better analyze the cyst 390 that may have been obscured by the vastus medialis muscle 320. In this way, aspects of the present disclosure can allow for more insightful levels of analysis of a reconstructed 3-D structure by isolating and moving or modifying various substructures based on measured density levels.

In general, aspects of the present disclosure can allow for users to analyze structures based on more than just visual inspection alone. The structures can include parts of the human body, where a user may be a doctor or medical scientist examining a patient. Visual examination can provide medical practitioners with vital diagnostic information. However, medical professionals cannot always satisfactorily diagnose patients from a static visual examination alone, particularly with images shown in only two dimensions. Medical problems might be missed or diagnosed incorrectly due to limitations of visual examination. Improved visualization could be helpful in obtaining accurate diagnoses. Being able to see a structure in three dimensions and to turn it so as to see it from every angle can increase the ability to obtain a proper diagnosis.

Palpating or touching internal structures can allow medical professionals to have more information when diagnosing patients. However, palpating these internal structures conventionally often involves invasive medical procedures that carry risks to the patient. In other instances, physical exploratory surgery is not even available for certain internal structures.

Aspects of the present disclosure can address these and other issues as well as improve diagnoses. Structural density provides diagnostic data that is useful to radiologists and other medical practitioners. By palpating virtual internal structures of a patient, the medical practitioner can obtain data unavailable from visualization alone. Because different tissues have different densities, the medical professional can feel the density of a structure and gain more information that way. By touching a structure and determining its density, a medical practitioner can increase accuracy and hit rate for detecting anomalies and pathologies. While the 3-D structures obtained from medical imaging can be divided into pieces, each of which is an accurate representation of that piece of the structure, and the interior of a structure can then be observed, if the division is not made in the right spot, the diagnostician may not see the anomaly. By palpating the structure, a radiologist may locate harder or softer places within the structure that are not immediately visible. In addition, filtering the density data can make it easier for medical practitioners to reveal the structure.

In other cases, aspects of the present disclosure can be used for other analyses besides medical diagnoses. For example, the principles described herein can be used for mechanical and electrical diagnosis, say to examine parts of a jet engine or a combustible engine. Other professional fields may also utilize the present disclosures, such as veterinary and biological research fields.

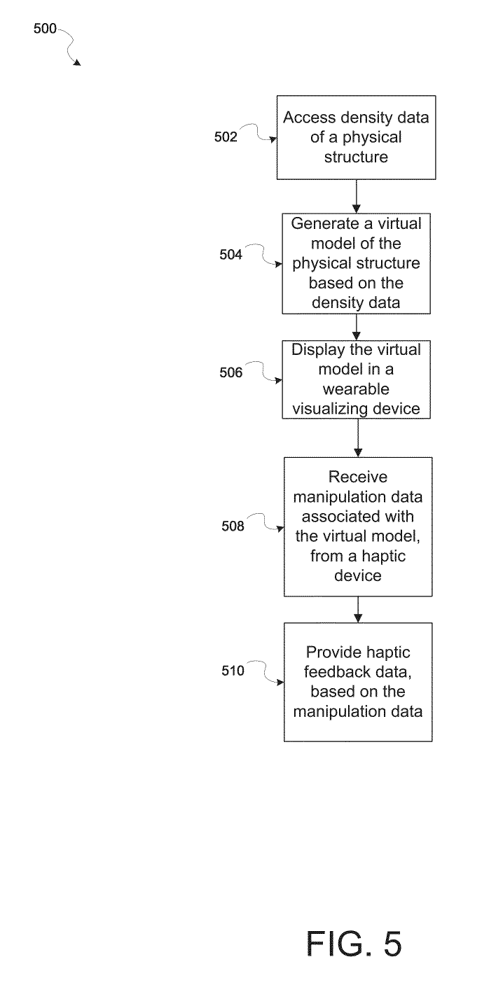

Referring to FIG. 5, the flowchart illustrates an example method 500, according to some example embodiments, for visualizing a structure in a virtual 3-D environment and for interacting with the structure. The example method 500 may be consistent with the various embodiments described herein, including, for example, the descriptions in FIGS. 1-4, and may be directed from the perspective of a wearable visualization device configured to display a 3-D virtual image of a physical structure in a user's field of view, such as the device 200.

At operation 502, the wearable visualization device may access density data of a physical structure. Examples of density data can include data from MRI or CT scans, consistent with those described above, or other methods for determining various densities of a structure, including x-rays and sonar functionality. Examples of the physical structure can include a section of a patient's body, including one or more internal organs. Other examples can include mechanical or electrical structures, such as engines or batteries. The wearable visualization device may access the density data from a number of sources, including a database residing in memory of a server, such as server machine 110 and/or database 115 in the network-based system 105. The wearable visualization device may receive this data via wired or wireless means.

As shown at operation 504, the wearable visualization device may generate a virtual model of the physical structure based on the density data. In some cases, the virtual model is a three-dimensional image of the physical structure. Example processes for generating the virtual model may be consistent with the descriptions in FIGS. 1-4. For example, a processor of the wearable visualization device may reconstruct a 3-D image of the physical structure based on multiple cross-sections of the physical structure containing density data. In some example embodiments, the virtual model may be generated in another device such as in the server machine 110 of the network-based system 105. The virtual model may then be transmitted to the wearable visualization device.

Referring to operation 506, the wearable visualization device may display the virtual model, which may be viewable by a user of the wearable visualization device. Example processes for displaying the virtual model may be consistent with the descriptions in FIGS. 1-4.

At operation 508, the wearable visualization device may receive manipulation data associated with the virtual model from a haptic device. An example of the haptic device may include the device 200, configured to receive haptic inputs and provide haptic feedback. Examples of manipulation data can include data associated with interacting with or manipulating the virtual model, and may be consistent with the descriptions in FIGS. 1-4 describing how the device 200 can “touch” the virtual 3-D image. For example, the manipulation data can include data associated with the user passing his hands over or through the space projected to be occupied by the virtual 3-D model.

The wearable visualization device may provide haptic feedback data to the haptic device, as shown at operation 510, based on the manipulation data received from the haptic device. In some cases, the haptic feedback data may also be based on a level of density of the virtual 3-D model that the haptic device is interacting with. Examples of the haptic feedback data can be data associated with providing a vibrating sensation, a heat sensation, or a degree of resistance that can be expressed in the haptic device, based on a level of density in one or more particular areas in the virtual 3-D image. Other examples of providing haptic feedback data may be consistent with any of the embodiments described in FIGS. 1-4.

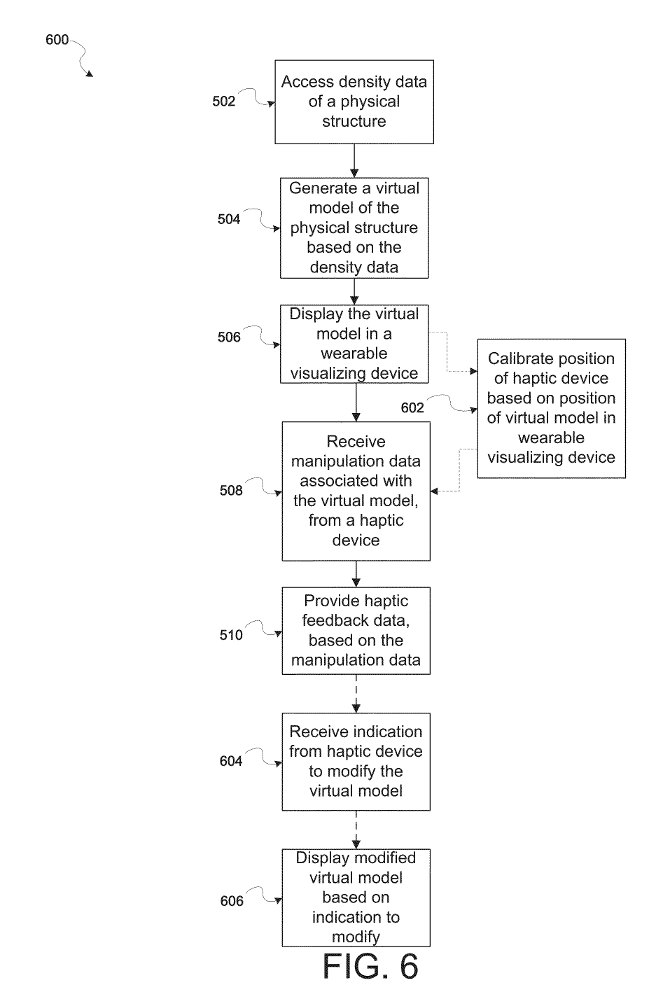

Referring to FIG. 6, the flowchart illustrates another example method 600, according to some example embodiments, for visualizing a structure in a virtual 3-D environment and for interacting with the structure. The example method 600 may illustrate additional operations, and may be consistent with the methods and embodiments described herein, including, for example, the descriptions in FIGS. 1-4.

Here, in addition to operations 502-510, the example methodology 600 may include operation 602, in some cases occurring after displaying the virtual 3-D model in the wearable visualization device. Specifically, at operation 602, the wearable visualization device may assist in calibrating a position of the haptic device based on a position of the virtual 3-D model displayed in the wearable visualization device. For example, location sensors associated with the haptic device, such as location calibration sensors 270 (FIG. 2), may have their positions calibrated to a relative position of the displayed virtual 3-D model. Example process of this calibration may be consistent with the descriptions in FIG. 2. Once the position of the haptic device is calibrated with the position of the virtual 3-D model, the example methodology 600 may continue to operation 508, described above.

In some example embodiments, at operation 604, the wearable visualization device can receive an indication from the haptic device to modify the virtual 3-D model. For example, the wearable visualization device may receive manipulation data from the haptic device two modify or remove a part of the virtual 3-D model in order to better interact with other parts of the virtual 3-D model. In some example embodiments, this indication may also be based on a subsection of the virtual 3-D model that has a consistent density. The indication to modify the virtual 3-D model may then be based on modifying or removing a subsection of the virtual 3-D model having a consistent density throughout. An example of providing this indication may be consistent with the descriptions in FIG. 4. In some example embodiments, operation 604 may be performed after operation 510; in other cases, operation 604 may occur in conjunction with operations 508 and 510.

In some example embodiments, at operation 606, the wearable visualization device may display a modified version of the virtual 3-D model based on the indication to modify the virtual 3-D model from operation 604. For example, the modified virtual 3-D model may display the original 3-D model but with a subsection of it modified or removed. For example, a section of muscle or other internal structure of a 3-D model of the patient's knee may be removed, revealing other parts of the patient's knee in the modified 3-D model. Other examples of displaying the modified virtual 3-D model may be consistent with the descriptions in FIG. 4.

Referring to FIG. 7, the block diagram illustrates components of a machine 700, according to some example embodiments, able to read instructions 724 from a machine-readable medium 722 (e.g., a non-transitory machine-readable medium, a machine-readable storage medium, a computer-readable storage medium, or any suitable combination thereof) and perform any one or more of the methodologies discussed herein, in whole or in part. Specifically, FIG. 7 shows the machine 700 in the example form of a computer system (e.g., a computer) within which the instructions 724 (e.g., software, a program, an application, an applet, an app, or other executable code) for causing the machine 700 to perform any one or more of the methodologies discussed herein may be executed, in whole or in part.

In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a distributed (e.g., peer-to-peer) network environment. The machine 700 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 724, sequentially or otherwise, that specify actions to be taken by that machine. Further, while only a single machine 700 is illustrated, the term “machine” shall also be taken to include any collection of machines that individually or jointly execute the instructions 724 to perform all or part of any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a video display 710 (e.g., a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a cursor control device 714 (e.g., a mouse, a touchpad, a trackball, a joystick, a motion sensor, an eye tracking device, or other pointing instrument), a storage unit 716, a signal generation device 718 (e.g., a sound card, an amplifier, a speaker, a headphone jack, or any suitable combination thereof), and a network interface device 720.

The storage unit 716 includes the machine-readable medium 722 (e.g., a tangible and non-transitory machine-readable storage medium) on which are stored the instructions 724 embodying any one or more of the methodologies or functions described herein, including, for example, any of the descriptions of FIGS. 1-6. The instructions 724 may also reside, completely or at least partially, within the main memory 704, within the processor 702 (e.g., within the processor 702's cache memory), or both, before or during execution thereof by the machine 700. The instructions 724 may also reside in the static memory 706.

Accordingly, the main memory 704 and the processor 702 may be considered machine-readable media (e.g., tangible and non-transitory machine-readable media). The instructions 724 may be transmitted or received over a network 726 via the network interface device 720. For example, the network interface device 720 may communicate the instructions 724 using any one or more transfer protocols (e.g., Hypertext Transfer Protocol (HTTP)). The machine 700 may also represent example means for performing any of the functions described herein, including the processes described in FIGS. 1-6.

In some example embodiments, the machine 700 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions 724. The term “machine-readable medium” shall also be taken to include any medium, or combination of multiple media, that is capable of storing the instructions 724 for execution by the machine 700, such that the instructions 724, when executed by one or more processors of the machine 700 (e.g., processor 702), cause the machine 700 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium is non-transitory in that it does not embody a propagating signal. However, labeling the tangible machine-readable medium as “non-transitory” should not be construed to mean that the medium is incapable of movement; the medium should be considered as being transportable from one physical location to another. Additionally, since the machine-readable medium is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing anatomical data corresponding to a three-dimensional image of a physical structure;
causing display of the three-dimensional image of the physical structure using a wearable visualization device based on the anatomical data;
monitoring a position of a body member of a user of the wearable visualization device relative to a corresponding location on the physical structure displayed to the user in the three-dimensional image, the position of the body member being associated with a haptic device;
accessing density data corresponding to the location on the physical structure;
identifying haptic feedback data corresponding to the density data; and
causing the haptic device to provide haptic feedback corresponding to the location on the physical structure.

2. The method of claim 1, further comprising calibrating a position of the haptic device based on a position of the three-dimensional image displayed in the wearable visualization device.

3. The method of claim 1, further comprising receiving an indication from the haptic device to modify the three-dimensional image.

4. The method of claim 3, further comprising displaying a modified three-dimensional image in the wearable visualization device, based on the indication to modify the three-dimensional image.

5. The method of claim 4, wherein the modified three-dimensional image includes a subset of the physical structure being simulated by the three-dimensional image.

6. The method of claim 1, wherein the density data includes measurements of density based on magnetic resonance imaging (MRI) or computerized tomography (CT) scans of the physical structure, and the three-dimensional image of the physical structure is based on cross-sections of the MRI or CT scans of the physical structure.

7. The method of claim 1, wherein the haptic feedback data includes data indicative of a plurality of haptic sensations corresponding to varying degrees of density in the three-dimensional image.

8. A wearable visualization device comprising:
a memory configured to store density data of a physical structure;
one or more processors coupled to the memory and configured to:
generate a three-dimensional image of the physical structure based on the density data;
access manipulation data associated with the three-dimensional image, from a haptic device; and
provide haptic feedback data associated with the three-dimensional image, to the haptic device, based on the manipulation data; and
a display module coupled to the one or more processors and configured to display the three-dimensional image in the wearable visualization device.

9. The wearable visualization device of claim 8, wherein the one or more processors is further configured to calibrate a position of the haptic device based on a position of the three-dimensional image displayed in the wearable visualization device.

10. The wearable visualization device of claim 8, wherein the one or more processors is further configured to receive an indication from the haptic device to modify the three-dimensional image.

11. The wearable visualization device of claim 10, wherein the display module is further configured to display a modified three-dimensional image in the wearable visualization device, based on the indication to modify the three-dimensional image.

12. The wearable visualization device of claim 11, wherein the modified three-dimensional image includes a subset of the physical structure being simulated by the three-dimensional image.

13. The wearable visualization device of claim 8, wherein the density data includes measurements of density based on magnetic resonance imaging (MRI) or computerized tomography (CT) scans of the physical structure, and the three-dimensional image of the physical structure is based on cross-sections of the MRI or CT scans of the physical structure.

14. The wearable visualization device of claim 8, wherein the haptic feedback data includes data indicative of a plurality of haptic sensations corresponding to varying degrees of density in the three-dimensional image.

15. A computer-readable medium embodying instructions that, when executed by a processor, perform operations comprising:
accessing density data of a physical structure;
generating a three-dimensional image of the physical structure based on the density data;
displaying the three-dimensional image in a wearable visualization device;
receiving manipulation data associated with the three-dimensional image, from a haptic device; and
providing haptic feedback data associated with the three-dimensional image, to the haptic device, based on the manipulation data.

16. The computer-readable medium of claim 15, the operations further comprising calibrating a position of the haptic device based on a position of the three-dimensional image displayed in the wearable visualization device.

17. The computer-readable medium of claim 15, the operations further comprising receiving an indication from the haptic device to modify the three-dimensional image.

18. The computer-readable medium of claim 17, the operations further comprising displaying a modified three-dimensional image in the wearable visualization device, based on the indication to modify the three-dimensional image.

19. The computer-readable medium of claim 18, wherein the modified three-dimensional image includes a subset of the physical structure being simulated by the three-dimensional image.

20. The computer-readable medium of claim 15, wherein the density data includes measurements of density based on magnetic resonance imaging (MRI) or computerized tomography (CT) scans of the physical structure, and the three-dimensional image of the physical structure is based on cross-sections of the MRI or CT scans of the physical structure.
